(19) United States
(12) Patent Application Publication
(10) Pub. No.: US 2025/0285110 A1
(43) Pub. Date: Sep. 11, 2025

(54) COMPUTER IMPLEMENTED SYSTEMS AND METHODS

(71) Applicant: ELAS HOLDINGS PTY, Fortitude Valley, Queensland (AU)

(72) Inventor: Brendan LEE, Toowong, Queensland (AU)

(73) Assignee: ELAS HOLDINGS PTY, Fortitude Valley, Queensland (AU)

(21) Appl. No.: 18/862,401

(22) PCT Filed: Apr. 28, 2023
(86) PCT No.: PCT/GB2023/051133

§ 371 Date: Nov. 1, 2024

(30) Foreign Application Priority Data
May 1, 2022 (GB) 2206372.1

(51) Int. Cl. G06Q 20/38

(52) U.S. Cl. CPC G06Q 20/389; G06Q 20/3825

(57) ABSTRACT

The invention resides in a blockchain-implemented method of creating a tokenised resource having a predetermined and/or yet unknown digital product or outcome. The product format or outcome is pseudo-randomly determined and masked upon creation, and set in place by events prior to unmasking. The invention is applicable to digital equivalents of real-world resource or event, such as purchasing collectors' cards and partaking in games of chance that have pseudorandom outcomes. The requester of the token, who is the beneficiary of the product or outcome, makes a commitment prior to token creation and the corresponding proof is a factor in the outcome. The token defines a product or outcome having a format (F), wherein said format is determinable from a proof of the commitment, masked, and one of a plurality of formats (F). The token includes instructions configured to process the proof to unmask and determine the format. The instructions can be locked by a signature(s), and said signature is determined from the proof to unlock said instructions.

### FIELD

This disclosure relates generally to methods and systems for the deterministic random property definition of a tokenised resource, such as a digital product or outcomes. Examples utilise, at least in part, a distributed ledger (blockchain) to facilitate the secure and efficient creation and subsequent transfer of control of a masked product from one party to another. The product can be a sealed digital item e.g. a trading card, or a fixed outcome e.g. a move or action in a digital game. The product or outcome is unknown to the requester or issuer, and masked by a commitment that determines the format or outcome prior to unmasking, and the corresponding proof is used to unmask.

Further examples of the invention generally reside in a blockchain-implemented token generation, transfer and/or verification method that uses, processes and/or generates a blockchain transaction (MTx) that creates the masked product or outcome. The invention can reside in: a computer-based resource e.g. a node or a digital wallet arranged and configured to use or process the method; and a non-transitory computer-readable storage medium having stored thereon executable instructions that, as a result of being executed by a processor of a computer system to perform said methods.

### BACKGROUND

The Bitcoin (RTM) blockchain ledger as introduced in 2008 by Satoshi Nakamoto's whitepaper (https://bitcoin.org/bitcoin.pdf) is the most widely known blockchain and associated network/platform in use today. Therefore, Bitcoin (RTM) is referred to in the examples used herein. However, examples of the disclosure are not limited in this regard and alternative blockchain protocols and implementations fall within the scope of the present disclosure.

A blockchain transaction is a data structure formed in accordance with a blockchain protocol and comprises at least one input and at least one output. Examples of blockchain transactions having functional and transparent outputs are known from WO2021/250037, which is incorporated by reference herein in its entirety. FIG. 1 discloses such an example in which a logical sub-ledger of associated tokens issued by the same issuer is implemented on a blockchain ledger e.g. the Bitcoin (RTM) blockchain. The logical sub-ledger can be referred to as a Token Ledger, and indicates relationships between an establishment transaction, minting transaction and subsequent token exchange transactions.

Known tokens can be created to represent a quantity of tokenised asset or resource, said tokens are defined and known at the time of minting. However, the properties of known tokens cannot be masked in a way that inhibits bias, on the part of the issuer, or inhibit fraud on the part of the receiver, which can occur by manipulating the outcome. Manipulation can also occur, in part, when a company e.g. Panini (RTM) produces collectable trading cards in sealed packets because (i) the contents of such a packet can be known prior to sealing, and (ii) a recipient can fraudulently open and re-seal such packets. An improved token generation technique is sought, wherein the format or content of a token is ‘sealed’ to both the issuer and the recipient until irreversibly ‘opened’ and a deterministic outcome recorded.

### SUMMARY

Aspects and examples of the present disclosure provide techniques, protocols and systems for creating, using, processing, and transferring tokenised assets or resources via a blockchain (ledger), wherein the tokenised resource is a predetermined at the point of creation, yet masked and having an unknown digital product or outcome until it is revealed, processed or otherwise opened. In other words, the product format or outcome is pseudo-randomly determined and masked upon creation, and set in place by events prior to unmasking.

This disclosure relates to the deterministic and/or pseudorandom property definition of a tokenised resource, which occurs in real world events, such as purchasing collectors' cards and partaking in games of chance that have pseudorandom outcomes. To inhibit fraud, the format of the product or the pseudorandom outcome is deterministic. The format is masked upon creation of the token, said token having an output defining the product and its format. The output is bound upon creation to inhibit bias or fraud e.g. the format of the product is computationally bound i.e. masked. Masking means that the format is hidden e.g. covered, concealed and undetectable. Yet, however, the format is fixed at the point of creation at which time it was masked. The unmasking requires a set of instructions to be executed, said execution functioning to ‘unbind’ or unmask the format e.g. reveal the format.

In keeping with the Bitcoin (RTM) protocol as designed by Satoshi Nakamoto, the logic behind the outcome is not anonymous or indeterminable. The outcome is determinable such that the product or outcome created in a transaction output is fixed i.e. immutable or unchanging, despite transfer over the blockchain. Moreover, tokens are created on-chain and so the cryptographic enforcement, consensus mechanisms and security of the blockchain network are harnessed, plus the immutable, inspectable, timestamped record of the creation of a product or outcome is secured on-chain.

The invention generally resides in a method of utilising properties that were not known at the point of token creation, yet the format of the product or outcome of the token is determined, at least in part, by the yet unknown properties. Further, the requester of the token, who is the beneficiary of the product or outcome provided by a provider, makes a commitment prior to token creation and the corresponding proof is a factor in the outcome. For example, a requester provides a value to a provider, said value provided as part of a commitment scheme, and the provider uses that value to create a token that produces an outcome. The outcome can be a product. The product can have a format. The outcome and/or the format of the product can be masked when the token is created. The token can be provided with instructions that when processed together with the value, or proof of knowledge of said value e.g. demonstrating that they know the value as part of a reveal in a commitment scheme, reveals the outcome e.g. the format of the product.

The invention generally resides provides a computer-implemented method comprising: using, processing and/or generating a blockchain transaction (MTx) having at least one token-related output (T-UTXO) that creates and transfers a token (T) i.e. a blockchain token to a requester, wherein the token comprises a deterministic outcome from an output of the token. The deterministic outcome can be derived by processing instructions included in the token. The instructions are configured to process a commitment created or otherwise provided prior to the creation of the token. In this way, the commitment can determine the outcome. The outcome can be a product having a format from a set of formats. The token can mask the outcome until the instructions are processed e.g. processed in a subsequent blockchain transaction. The commitment can be an input value that is used to determine the outcome and/or format.

According to one aspect, there resides a computer-implemented method comprising; and using, processing and/or generating a blockchain transaction having at least one token-related output that creates and transfers a token to a requester. The token comprises: at least one output defining a product having a format, wherein said format is determinable from a proof of a commitment, masked, and one of a plurality of formats. The token also includes instructions configured to process the proof to unmask and determine the format. The method can include receiving the commitment e.g. a value from the requester.

The requester, who makes a commitment, is participating in a commitment scheme with the provider. The requester commits to a value while keeping it hidden. The requester is able to reveal the committed value later, or otherwise use said value. The requester can prove that they know the value by providing ‘proof’ that they know said value—with or without revealing the value. The requester, therefore, uses the commitment to bind themselves to the value so that they cannot manipulate an outcome or gain inappropriate advantage. The provider, similarly, binds the requester to using the value by defining the product with a format that is determined from a ‘proof’ of a commitment i.e. the requester must provide proof that they know the value. The format is masked i.e. unknown, and can only be determined by processing the instructions. The provider configures the instructions to require use of the value e.g. proof that the requester knows the value. When the requester processes the instructions using the value, or proof thereof, the format is revealed.

In a commitment, the commit phase can consist of a single message e.g. value from the requester to the provider, or their agent. This value is often referred to as the commitment. Normally, the reveal phase can consist of a single message, the opening, from the requester to the provider, followed by a check performed by the provider. While the requester can verify the message e.g. value, the provider incorporates the message e.g. value provided during the commit phase into a set of instructions that the requester must process, and the binding property of the commitment requires the requester to use the message e.g. value provided in the commit phase.

The commitment can take place in two phases: (1) In a first phase, e.g. a commit phase, a requester provides at least one value e.g. a public signature of a key-pair. Said public key can be used twice within the commitment. However, at least two values can be used in the commitment e.g. at least one of a digital signature, and a key e.g. a key, such as an ephemeral key. The key can be a deterministically generated number. Other values can include a message, which can be the communication from the requester to the provider. (2) In a second phase, e.g. an open phase, e.g. a reveal phase, in which the outcome is determined from the values in the first phase. In the second phase, the value provided by the requester in the first phase can be verified by the provider. The value can be revealed in the second phase. In the second phase, the requester can provide a proof of the commitment e.g. proof that they know the values. The proof can be a zero-knowledge proof. The format can be determined using a proof of the commitment. The format of the product, therefore, in unknown e.g. masked until the instructions within the token are processed using the knowledge of the values provided by the requester in the first phase.

The format is derived from an expected value, which is deterministic, yet unknown at the time the commitment is made. The commitment functions to provide a computationally binding outcome. The outcome is based on the values provided in the first phase. The values can include at least one of a digital signature of a key-pair, a key e.g. ephemeral key and a set value e.g. a set date and/or time in the future. The second phase requires a proof of the commitment to be processed within a set of instructions that reveal the binding outcome. The proof can be a zero-knowledge proof. The format can be determined using a proof of the commitment.

In the first phase, the requester can either provide the values directly to the provider for inclusion in the instructions, or the provider can send a template to the requester to complete with the values, and the requester can then send the completed template to the provider. For example, the requester can generate an unsigned transaction pre-image that meets specific requirements e.g. the transaction is final and/or the sequence value is final e.g. sequence value is FFFFF, which can then be hashed to generate a signature. The signature can be based on the transaction pre-image.

The commitment can be based on at least one of a digital signature, and key e.g. ephemeral key and an expected value to be derived from a future unknown value. The commitment functions to provide an input that is used to determine a computationally binding outcome, said outcome based on at least one of the digital signature, proof of the key e.g. ephemeral key and the expected value.

Alice can provide a public key to secure the token and its associated product. The signature can be used to determine the format of the product. Additionally or alternatively, the format of the product can be determined by Alice's commitment i.e. obligation or agreement to instructions using an expected value to determine the format of the product, wherein said expected value is a yet unknown unique parameter, e.g. a unique value extracted from a subsequent blockchain block. By way of example, the requester can provide a pseudo-random number to the provider, wherein said number is processed by the set of instructions to determine the format of a product. Additionally or alternatively, the requester can agree to process the set of instructions using a value that is deterministic, yet unknown e.g. if the requester provides a token within a transaction that is recorded in a blockchain block N, then the value can be a hash of the block header of the blockchain block N+10, or even N+100.

The product can be an asset or an outcome, which can be a status or configuration. For example, the product can be a digital asset, such as an image or object, such as a collectable card. The product can be a digital asset that is functional e.g. an object in a digital game e.g. an object such as a weapon or a building. The format of the product can determine its properties, which is one of a range of properties associated with the format. The outcome can be one of a predetermined number n of outcomes. An operand within the instructions can determine the outcome e.g. format of the token or the product of the token. The operand can produce a predetermined outcome m from a predetermined number n of outcomes. The outcome can be weighted. The commitment can comprise an input value e.g. a signature. The input value e.g. signature can be part of the commitment. The input value can be used to lock the instructions. In other words, a provider can use the input value e.g. signature by configuring the script of the token to reveal the token output or format only when knowledge of the input value e.g. signature is used to prove the commitment. Processing the knowledge of the signature in the script of the token can unmask the output e.g. format. The output e.g. format is determined from the input value e.g. signature.

The commitment comprises an input value, such as a digital signature, the input value is used to lock the instructions (m), and knowledge of the input value is used to determined a proof of the commitment, which is processed to unlock said instructions.

The commitment can include a signature. The signature is a digital signature. The signature can have a key-pair including a private key (SA). The instructions can be locked by a signature. The proof can unlock said instructions. Only the requestor knows the proof underlying the signature, and via the commitment, which is submitted to the requestor prior to minting the token, a token is only minted when the requestor uses their proof, or knowledge of the proof, to satisfy the instructions.

By way of example, the commitment can comprise a public key of a key-pair, and the proof of the commitment can be the corresponding private key.

In another example, the commitment scheme can, in the first phase, the requester can use a Public-Key-Hash (PKH), which the provider can embed in the instructions such that when processed i.e. the second phase of the commitment, the results are used to determine the outcome e.g. format of the product of the token.

The commitment can include at least one of (i) a public key (P_{A}) derived from a key-pair including a private key (SA), and a component (R) derived from a key e.g. ephemeral key (k). The commitment can include an additional or alternative as yet unknown unique parameter, e.g. a unique value extracted from a subsequent block e.g. the block-hash of the 20^{th}, 50^{th} or 100^{th} block or block-header following the minting transaction that produced the token, such that it is verified as valid by inclusion in a chain of at least 20, 50 or 100 valid headers, or the block—has of the transaction is eventually mined in. The public key (P_{A}) can be derived from P_{A}=S_{A}·G, wherein S_{A} is the private key, and G is an elliptic curve generator point. The commitment can be derived from R=k·G, wherein r is the x-coordinate of R, k is a key e.g. an ephemeral key, and G is an elliptic curve generator point.

The format of the product can be determined from an operation including at least one of (i) the proof of the commitment and/or the signature, and (ii) an operand that produces a predetermined number n of outcomes. By way of example, the operation can include executing the instructions to process at least one of the digital signature, proof of the key e.g. ephemeral key and the expected value. In other words, the commitment binds the recipient to prove that they know the value provided in the first phase of a commitment, and proof of the value, or the value itself, determines a future unknown value. The future unknown value can be subjected to an operation with an operand. The operand can be modulo n, wherein n is the maximum number of the plurality of formats. The operator can be selected to determine results within a range of values, from which a result can be determined.

In another example, the operand can be related to a function of the input e.g. at least one of the signature, parent TXID, a block parameter such as a version number, a block reference, a Merkle Root of the transactions within the block, a time-stamp, a difficulty rating, and a nonce. The function can be any computer algorithm or function where a set of functions is being generated based on a random input. An example can extend the length of the hash function to enable an XOR mask to be applied across a large number of parameters, each being randomised.

In another example, the input value uses biometric data e.g. facial recognition data, which is unique to an individual. A requester can provide a value that is based on their biometric data e.g. a hash of their biometric data. The outcome e.g. the format of the product output from the token provided by a requester, is based on the input value, which in this case is the requester's biometric data. The outcome can be determined from said input, wherein the instructions provided in the token use the input value as a ‘seed’ or starting point that is processed within the instructions. The process in the token instructions requires the requester to use their biometric data e.g. using facial recognition software, said biometric data then being used to determine the product output. The format can be determined using any technique e.g. a ‘bitwise’ operation or a number/divisor operation. The operation functions to produce a single result that determines the format from a range of possible results. The range of possible results can include sub-ranges, wherein the single result determines a format that corresponds to a sub-range.

The signature can be determined from the commitment. By way of example, the signature(s) is s=k−1(H(m)+SA*r) mod Q, wherein: k is the key e.g. ephemeral key, H(m) is a hash of the instructions e.g. a hash of the transaction pre-image, which can be a combination of factors of the transaction in a proscribed format, SA is the private key corresponding to the public key of the key-pair, r is the x-coordinate of R, and Q is the order of the private key space. In this example, the requester can provide the provider with their public key that corresponds to the private key used to determine the signature and the value of ‘R’. The method can comprise: providing a template set of instructions to the requester, and receiving the commitment e.g. the public key P and value ‘R’ embedded a the template set of instructions that determine the instructions e.g. the script on the output of the token that is processed to determine the product output or format.

The method can further include at least one of verifying: that the public key submitted is the requestor's public key, the commitment is that of the requestor, and checks a transaction pre-image to validate the transaction the requestor is signing meets predetermined criteria. The transaction pre-image validation determines that the instructions defining the format of the product are not being biased or fraudulently set. This can be achieved by a ‘pre-image’ of the instructions being verified e.g. using an OP_PUSH_TX. The pre-image check can force the transaction to adhere to a set of rules that limit the possible outcome of the signature process to a single value which can only be determined once the commitment transaction has been made final. This will ensure that Alice can only produce a single valid signature, and she is inhibited from being able to cycle through many signatures and/or values to generate a favourable outcome. The validation can be an automated validation that the instructions executed to unmask the format of the product are a valid representation of the instructions at the time the product was minted. Part of this pre-image check can force the transaction to adhere to a set of rules that limit the possible outcome of the signature process to a single value which can only be determined once the commitment transaction has been made final. This will ensure that the redeeming party can only produce a single valid signature rather than being able to cycle through many signatures to generate a favourable outcome.

The token can have a plurality of outputs, each output defining a product having a format; and/or the blockchain transaction can have a plurality of token-related output, each output creating and transferring a token to the requester. A commitment can be provided for each product.

The blockchain transaction can further include at least one of: a signature of the provider unlocking the blockchain transaction; an input and/or an output UTXO of a provider; a quantity of token-related cryptocurrency; providing the or each token output with a quantity of token-related cryptocurrency; and providing the or each token with a quantity of token-related cryptocurrency.

The instructions can determine a value from a range of n, wherein n is the maximum number of the plurality of formats. The determined value can be a sub-range of n outcomes, wherein said value determines the format of the product. The instructions can determine a value m from the range of n outcomes e.g. the outcome n can be any integer number, while the value is determined according to whether the number is odd or even.

Additionally or alternatively, the value can be calculated from a deterministically random outcome by processing the commitment with a yet unknown value. By way of example, the yet unknown value is unique, and can be extracted from a future block on the blockchain, and can comprise, by way of non-limiting examples, at least one parameter from a block header. Parameters can comprise: a version number; a block reference, a Merkle Root of the transactions within the block; a time-stamp; a difficulty rating; and a nonce. The future block can be set as, for example, the tenth, 50th or even 100th block following the block in which the minting transaction of the token occurred.

According to another aspect, there resides a computer-implemented method comprising: requesting from a provider a blockchain transaction having at least one token-related output that creates and provides a token, wherein the token comprises at least one output defining a product having a format, wherein said format is one of a plurality of formats, determinable from a commitment and, masked; sending a commitment to the provider, or receiving a template set of instructions from the provider, completing the template set of instructions with a commitment, and sending the completed template to the provider; and processing the instructions to unmask and determine the format. The method can further comprise executing instructions of the token using the commitment and unmasking and determining the format of the product. The product can be a digital asset or a digital outcome.

According to another aspect, there resides computer-implemented method comprising: requesting from a provider a blockchain transaction (MTx) having at least one token-related output (T-UTXO) that creates and provides a token (T), wherein the token comprises at least one output defining a product (C) having a format (F), wherein said format is one of a plurality of formats (F), determinable from a commitment and masked, and instructions (m) configured to process the commitment to unmask and determine the format (F); sending a commitment (PA, R) to the provider for processing by the provider to generate a set of instructions for inclusion in the blockchain transaction, or receiving a template set of instructions from the provider, and completing the template set of instructions that determine instructions with a commitment (PA, R), and sending the completed template to the provider; and receiving the blockchain transaction and processing the instructions (m) within the blockchain transaction using a proof of the commitment to unmask and determine the format (F).

According to another aspect, there resides computer-implemented method comprising: providing to a requester a blockchain transaction (MTx) having at least one token-related output (T-UTXO) that creates and provides a token (T), wherein the token comprises at least one output defining a product (C) having a format (F), wherein said format is one of a plurality of formats (F), determinable from a commitment and masked, and instructions (m) configured to process the commitment to unmask and determine the format (F); receiving a commitment (PA, R) from the requester for processing by the provider to generate a set of instructions for inclusion in the blockchain transaction, or sending a template set of instructions to the requester, and receiving a completed template set of instructions that determine instructions, said completed template including a commitment (PA, R); and broadcasting the blockchain transaction and for the requester to process, wherein the instructions (m) within the blockchain transaction use a proof of the commitment to unmask and determine the format (F).

The commitment can have a corresponding proof, and the format can be defined by the proof of the commitment. The proof can be processed to unmask and determine the format. The method can further comprise executing instructions of the token using the proof of the commitment and unmasking and determining the format of the product.

According to another aspect, there resides computer equipment having memory comprising one or more memory units; and processing apparatus comprising one or more processing units, wherein the memory stores code arranged to run on the processing apparatus, the code being configured so as when on the processing apparatus to perform the method of any of the claims herein.

According to another aspect, there resides a computer program embodied on computer-readable storage and configured so as, when run on one or more processors, to perform the method of any of the claims herein.

According to another aspect, there resides a non-transitory computer-readable storage medium having stored thereon executable instructions that, as a result of being executed by a processor of a computer system to perform the methods claimed herein.

The controller can process instructions on the output of a respective token's blockchain transaction. The instructions can be script.

According to another aspect the invention resides in a system having a device configured to manage one or more token-related outputs (T-UTXO), each of which represents a respective token (T) issued by a Token Issuer (TI). The system includes a processor configured to: receive from a requester a commitment; use, process and/or generate a blockchain transaction having at least one token-related output that creates and transfers a token to the requester, wherein the token has at least one output defining a product having a format, wherein said format is determinable from a proof of the commitment, masked, and one of a plurality of formats. The token is configured by the processor to include instructions configured to process the proof to unmask and determine the format.

According to another aspect the invention resides in a device, operable in a control system, said device having: a controller configured to processing and/or generating a blockchain transaction, said blockchain transaction having one or more token-related outputs.

Each system and/or device can be configured to manage at least one token on a cryptocurrency blockchain and create a token transaction that indicates the operation, status and data that determines the configuration of at least one token, as claimed.

According to another aspect of the invention, there resides a digital wallet arranged and configured to manage the token transaction of a token that determines the status or format of a token.

According to another aspect of the invention there is a computer implemented method of performing a token transaction of a token that determines the status of a device, said method including generating, storing, processing and/or maintaining a computer-based resource of a plurality of token-related blockchain transaction outputs, wherein each of the outputs is a token having a masked and predetermined format. The computer-based resource can be generated, stored, processed and/or maintained off-chain.

According to another aspect of the invention, there resides a computer network comprising a plurality of nodes, wherein each node in the computer network comprises: a processor; and memory including executable instructions that, as a result of execution by the processor, causes the system to perform a method disclosed herein, such as a token transaction of a token that determines the status of a token.

According to another aspect of the invention, there resides a non-transitory computer-readable storage medium having stored thereon executable instructions that, as a result of being executed by a processor of a computer system, cause the computer system to perform the aforementioned computer-implemented method disclosed herein, such as a token transaction of a token that determines the status of a token.

### BRIEF DESCRIPTION OF THE DRAWINGS

Aspects and examples of the present disclosure will now be described, by way of example only, and with reference to the accompany drawings, in which:

FIG. 1 is a flowchart illustrating steps in an example of the disclosure.

FIG. 2 illustrates the actions taken by a requester and a provider during the configuration and issuance of a masked token output;

FIG. 3a shows an example of a minting transaction creating a token having a masked product and a subsequent transaction in which the product is unmasked, while FIG. 3b shows the relationship between the components of FIG. 3a;

FIGS. 4a and 4b are, respectively, the steps taken by the Provider and the Requester in the process shown in FIG. 2 that generates a token as illustrated in FIGS. 3a and 3b; and

FIG. 5 is a system diagram of a device, such as a node or computational unit.

### DETAILED DESCRIPTION OF ILLUSTRATIVE EXAMPLES OF THE DISCLOSURE

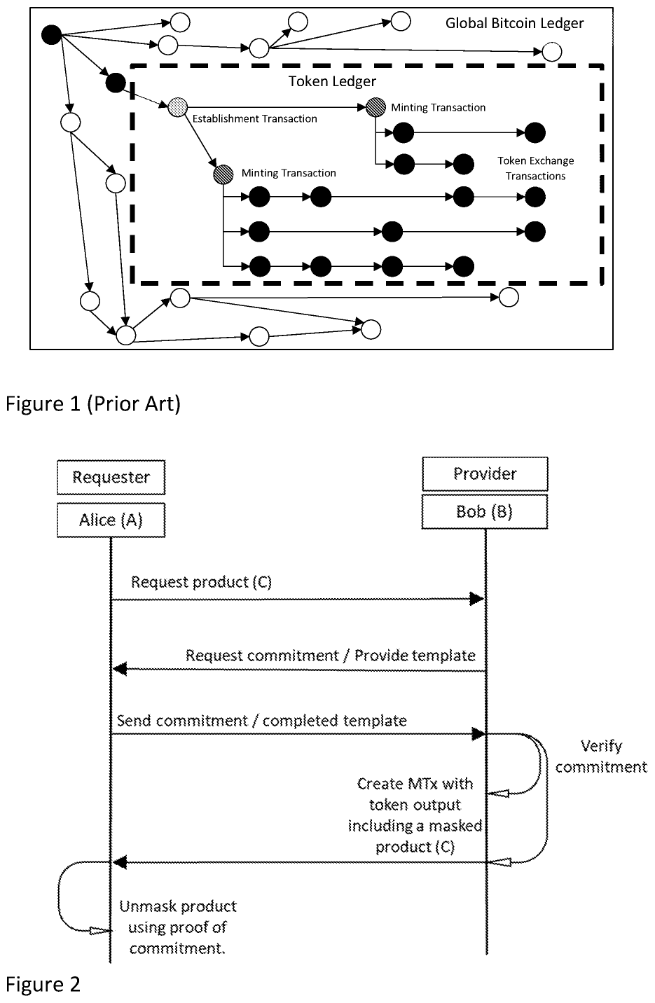

Examples of some possible examples and use cases are now provided for the purpose of illustration, without limitation. As explained above, for the sake of convenience only, we will refer herein to “Bitcoin (RTM)” for our examples as it is the most well-known and widely used blockchain protocol. Examples of the disclosure may be implemented on the Bitcoin (RTM) protocol, platform and ledger, although this and the references to Bitcoin (RTM) are not intended to be limiting and the scope of examples of the present disclosure is not thus restricted. FIG. 1 and the associated operations and functions of creating and managing tokens are known, and disclosed in WO2021/250037, which is incorporated by reference herein in its entirety

### General Overview

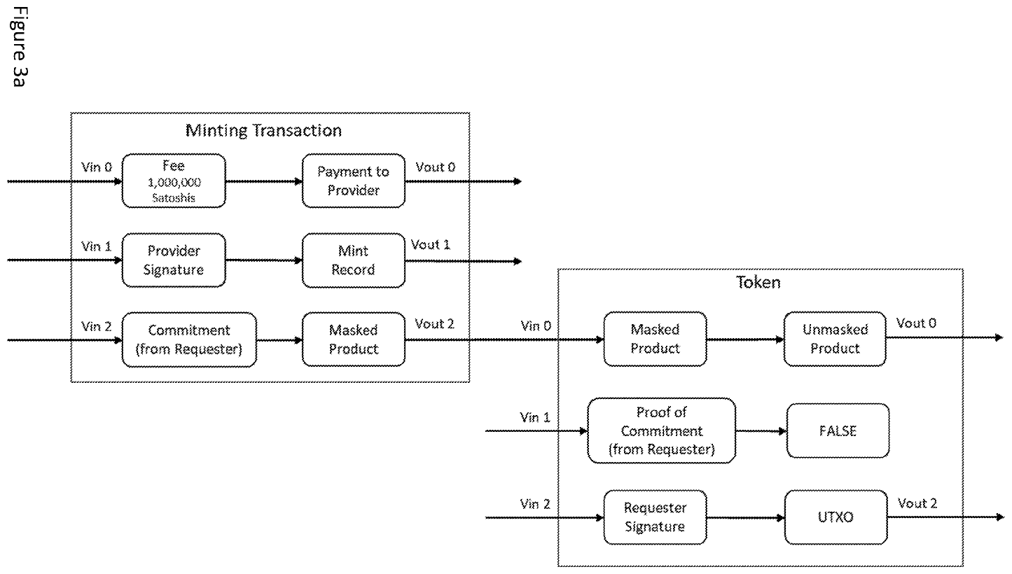

FIG. 2 illustrates a relationship between Alice and Bob, who are the requestor and provider, respectively, of a token (T). The token has an output that defines a product or an outcome, and examples are provided further below for applications including a trading card and a ‘roll of a dice’, although the invention is not limited to such examples. At a more general level the product or outcome has one of a plurality of possible formats. Hereinafter the tokenised resource is referred to a ‘product’, which can represent a digital asset, score, grade, etc. The plurality of possible formats can be described as a set, wherein the set is an integer value of at least two.

Alice initially requests from Bob a token. Bob, or one of his representatives, which could be a host service provider, obtains from Alice a commitment. Alice can provide this together with her request if she has obtained tokens previously and is familiar with the requirements, but Bob must obtain a commitment prior to issuing a token. In other words, Alice provides a value as part of a first phase of the commitment scheme. The commitment i.e. the value provided by Alice, is used to compile the instructions that will eventually unmask the format of the product included in the token output. In other words, Bob creates instructions that processes the value, or proof thereof, thus performing the second phase of the commitment scheme. Instructions can alternatively be referred to a ‘script’, and provide a mechanism for securing the mask until a proof of the commitment is provided to unmask the format.

The commitment can be inserted or compiled into instructions upon receipt by Bob, or Bob can provide a template e.g. a pro-forma script or form that Alice completes by adding the details of her commitment. If Alice holds a copy of the template she could provide a completed set of instructions directly to Bob. In practice, Alice is likely to provide her commitment via an API on an electronic device, and the generation of the commitment can be managed by Alice's digital wallet, which creates the commitment and stores the proof on Alice's behalf.

Prior to creating a transaction that issues a token to Alice Bob can perform at least one verification process e.g. checking Alice's public key to which the token is to be assigned, checking the commitment provided or testing the script in the token.

After obtaining the commitment and compiling the instructions Bob generates a blockchain transaction having at least one token-related output that creates and transfers a token to Alice. The input to the transaction can include Bob's signature and/or at least one of an issuer's signature or an authority signature, such that the authenticity of the token, and the product derived therefrom, can be verified on chain e.g. through a linear transaction history.

The token issued by Bob to Alice is controllably secured by Alice because the associated UTXO has been spent to her address and a further transaction requires her corresponding private key. In other words, the UTXO that defines the token and/or the product it defines is locked by a script that only Alice can solve i.e. unlock. The token includes at least one output defining a product, wherein the format is masked. The format is one a plurality of formats, but is unknown and cannot be determined until instructions within the output of the token are processed. The instructions, however, have been configured with the commitment provided by Alice. Only when Alice processes the instructions with her proof can the format of the product be unmasked and determined. The format can be determined by Alice's proof of the commitment (i) when the commitment is based upon information provided by Alice e.g. a public key (PA) derived from a key-pair including a private key (SA) and/or a component (R) derived from a key e.g. an ephemeral key (k) and/or (ii) a future unknown value, which can be subjected to an operation with an operand.

The instructions (m) can be locked by a signature(s). The instructions can be secured e.g. hashed before the transaction is made and ultimately appears on-chain. The signature can be determined from the proof to unlock said instructions.

In addition to, or as part of the commitment, Alice can provide Bob with at least one of: a public key (P_{A}) derived from a key-pair including a private key (S_{A}); and a component (R) derived from a key e.g. an ephemeral key (k). Bob can assign the token to an address, the public key or an address derived from the public key—in this way Alice possess control of the token UTXO and can make a further transaction. The component operates, at least in part, as the commitment, wherein the key e.g. ephemeral key is kept secret by Alice as part of the proof to the commitment.

The public key (P_{A}) is derived from

$${P}_{A =} {S}_{A} \cdot G$$

wherein, S_{A} is the private key, and G is an elliptic curve generator point.

The component (R) is derived from

R=k·G, wherein ‘r’ is the x-coordinate of R

wherein r is the x-coordinate of R, k is a key e.g. an ephemeral key, and G is an elliptic curve generator point e.g. the secp256k1 elliptic curve.

The instructions can include at least one operation that processes the commitment, which can involve processing at least one of: a private key (S_{A}) corresponding to the public key (P_{A}) derived from a key-pair; a key e.g. an ephemeral key (k) that was used to generate the component (R); and the expected value that Alice was bound to prior to the token being generated by Bob—said processing determining the format of the product (C). The operation can include processing the proof of the commitment and/or the signature. In this way, the information provided by Alice, and can be secretly held and known only to Alice, is embedded in the instructions prior to the issue of the token containing the product, and thereafter the information is instrumental to the deterministic outcome of the operations within the instructions.

The instructions can be implemented as script in the output of a blockchain transaction. The instructions can be executed to define the product and its format.

The instructions are part of a ‘transaction message’. By way of example, using the Bitcoin (RTM) protocol, Alice's commitment can use a signature e.g. an elliptic curve signature, to sign a hash of the “transaction message”. This enables nodes to validate the signature during the process of validating transactions. The instructions comprise a plurality of elements that require verification.

To inhibit the outcome being biased or fraudulently set, a ‘pre-image’ of the instructions can be verified e.g. using an OP_PUSH_TX, which can use messages, secured by signatured e.g. ECDSA signature messages to access and enforce the operations within the instructions. The technique requires the user or process that is using the UTXO to push the transaction pre-image message that is used to generate the signature onto the stack as part of the input scriptSig. In particular, the technique ensures Alice is required to process the instructions as issued by Bob

Part of this pre-image check can, therefore, force the transaction to adhere to a set of rules that limit the possible outcome of the signature process to a single value which can only be determined once the commitment transaction has been made final. This will ensure that Alice can only produce a single valid signature, and she is inhibited from being able to cycle through many signatures and/or values to generate a favourable outcome.

Overall, the use of a commitment embedded within the instructions results in an operation that determines the format of the product, but the result of the operation cannot be calculated in advance. The result of processing the instructions with the proof of the commitment provides a result that is one of a set valid, possible, results—the result is analogous to a distinct key of a given cryptosystem having a given key space. For the avoidance of doubt, the commitment and corresponding proof in combination with the instructions are such that the result of the operation cannot be calculated in advance.

Upon executing the instructions, the proof is used to determine a result that is subject to an operation. The operation determines the format of the product from a plurality of potential formats. The operation uses an operand that produces a predetermined number n of outcomes. The format of the product (C) can be determined from an operation including the signature and an operand that produces a predetermined number n of outcomes. The outcomes produce, by way of example (i) a value m determined from a range of n outcomes, e.g. e.g. roll a 6-sided dice with equal odds, using mod 6, wherein n=6 and m=6, or (ii) a value m determined from a sub-range of n outcomes, wherein said value determines the format of the product (C) e.g. e.g. roll a 6-sided dice with weighted odds, using mod 21, wherein n=21 and m=6.

The format can have a direct relation with the number of values from the operation e.g. the operation can result in 99 values, and there can be 99 different formats. Alternatively, a group of values can determine a format of the product e.g. the operation can result in 12 outcomes, nominally values 1 to 12, wherein the product has: a first format if the outcome is any one of the values 1 to 4; a second format if the outcome is any one of the values 5 to 8; a third format if the outcome is any one of the values 9 to 12. The relationship between the outcomes can be non-linear e.g. the operation can result in 12 outcomes, nominally values 1 to 12, wherein the product has: a first format if the outcome is any one of the values 1 to 11; a second format if the outcome is 12.

By way of example, during execution of the instructions, the proof is used to determine a result that is subject to an operation. By way of non-limiting example, the result, which cannot be calculated in advance, is then subject to at least one of: a modulo operation, wherein operand is modulo n, wherein n is the maximum number of the plurality of formats (F); a ‘bitwise’ operation; a ‘number-divisor’ operation; and an XOR function. Overall, the range n of possible values is possible. The format can be determined by a sub-range of the possible values.

### Determined Outcome of the Format

The instructions can deterministically define the format of the product or the outcome. In one example, the format is defined, masked and fixed at the time of token creation. When fixed, the instructions can be configured in order that the format cannot be calculated. The instructions can use ECDSA techniques to secure the mask such that only knowledge of Alice's proof can unmask the format.

By way of example, the format can be determined from the signature, and the signature can be subject to an operation e.g. modulo n, wherein n is the maximum number of the plurality of formats (F). The instructions can be configured to determine the format from a sub-range of the possible outcomes.

By way of example, the commitment from Alice can include a public key (P_{A}) and a component (R), as described above, and the instructions can be configured to determine a signature(s), wherein

$$s = {k}^{- 1} ( H ( m ) + {S}_{A} * r ) mod Q$$

wherein
k is the key e.g. ephemeral key,
H(m) is a hash of the instructions,
S_{A} is the private key corresponding to the public key (P_{A}) of the key-pair,
r is the x-coordinate of R, and
Q is the order of the private key space.

Therefore, the format of the product (C) is determined from

format=s mod n

wherein
format is a value representing the format of the product (C),
s is the proof of the commitment, and
n is the maximum number of possible formats.

Alternatively, therefore, the format of the product (C) is determined from

format=H(s)mod n

wherein
format is a value representing the format of the product (C),
H(s) is a hash of the proof of the commitment, and
n is the maximum number of possible formats.

The format can be a value from a range of n of outcomes, or a sub-range of n of outcomes, wherein said value determines the format of the product (C)

Alternatively, the format of the token can be deterministically random by configuring the instructions to require Alice's commitment to be processed together by a yet unknown value. The yet unknown value is unique, and can be extracted from a future block on the blockchain, and can comprise, by way of non-limiting examples, at least one parameter from a block headers. Parameters can comprise: a version number; a block reference, a Merkle Root of the transactions within the block; a time-stamp; a difficulty rating; and a nonce. The future block can be set as, for example, the tenth, 50^{th} or even 100^{th} block following the block in which the minting transaction of the token occurred.

Upon receipt of the commitment from Alice e.g. Bob receives a public key (P_{A}) and a commitment (R) submitted by Alice, Bob can prepare and check a transaction pre-image to validate the transaction. In this way Bob can verify the transaction prior to issuing the token to ensure that instructions in the token that Alice has to sign meets predetermined criteria.

The methods above describe a scenario in which Alice requests one product, said product having a masked format, and said format is determined by the commitment provided by Alice to Bob. Alice can request a plurality of products and provide a corresponding number of commitments e.g. one commitment per product. Bob can create a single transaction and generate a single token having a plurality of outputs, wherein an output is assigned to a product. Instructions can be provided for each product and commitment, or the instructions can be used for a plurality of products. Additionally or alternatively, Bob can issue a token for each product requested by Alice. In other words, a token can have a plurality of outputs, each output defining a product (C) having a format (F); and/or the blockchain transaction (MTx) has a plurality of token-related output (T-UTXO), each output creating and transferring a token (T) to Alice. In each case, a commitment is provided for each product (C).

The blockchain transaction (MTx) can further include at least one of: a signature of the provider e.g. Bob, for unlocking the a blockchain transaction (MTx); an input and/or an output UTXO of a provider; a quantity of token-related cryptocurrency (TRC); provide the or each token output with a quantity of token-related cryptocurrency (TRC); and provide the or each token with a quantity of token-related cryptocurrency (TRC).

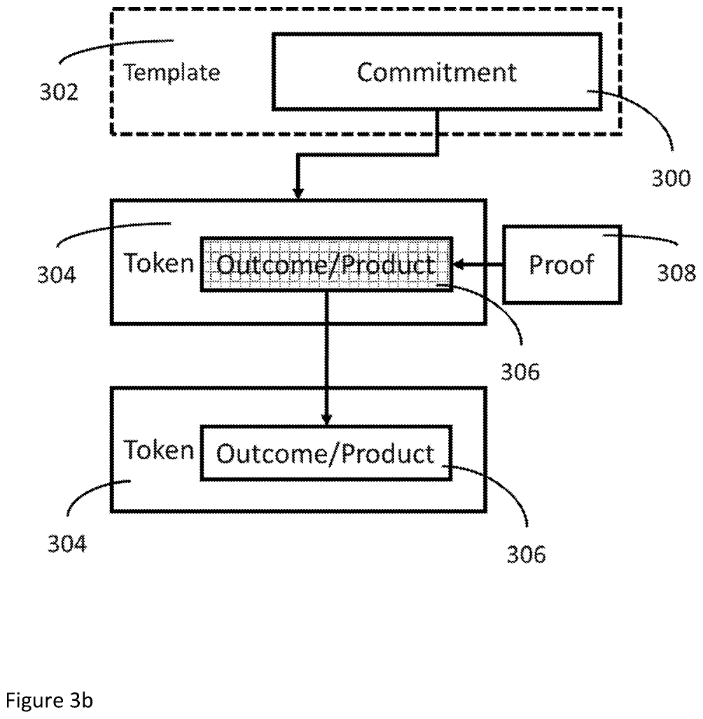

FIG. 3a illustrates an example, including a series of two transactions, in which Alice provides a commitment and pays a fee to Bob in exchange for a token. The first in the series is a minting transaction (MTx) performed by Bob, wherein the input and output pairs are: a fee at Vin0 comprising a UTXO representing 1000000 Satoshis, provided by Alice in exchange for a token containing a masked product, which is paid to Bob at Vout0; Bob's signature at Vin1, which produces a corresponding Mint Record at Vout1; and a commitment from Alice at Vin2, which is compiled such that the output at Vout2 is UTXO representing a token, assigned to Alice's address and represents the product having a masked format. Only one masked product is provided at Vout 2

In this example, the token generated from the Minting Transaction has the following input and output pairs: the masked product, at Vin0, defined by the instructions or script, which when processed and verified unmasks and determines the format of the product at Vout0; the instructions require the commitment to be processed e.g. proof of the commitment, provided at Vin1, that are used in the instructions and has no output, and terminated by, for example, by an OP_RETURN; and Alice's signature or private key corresponding to the address or public key provided, which can be provided as part of the commitment, which is required to manage the UTXO e.g. transfer the token back to herself, or sell/transfer the token and the unmasked product to a third party.

Following the Minting Transaction, there is a UTXO defining a product, and the format of said product is masked. Unmasking the product requires the associated instructions e.g. script of the UTXO to be processed. The configuration of the token shown in FIG. 3a is for illustrative purposes only, and in this example the input to Vin1 can be proof of the commitment and/or the expected value that Alice previously committed to. Processing the UTXO at Vin0 can include receiving at least one of: Alice's private key (S_{A}) corresponding to the public key (PA) derived from a key-pair, e.g. via Vin2; a key e.g. an ephemeral key (k) that was used to generate the component (R) e.g. at Vin1; and the expected value that Alice was bound to prior to the token being generated by Bob e.g. at Vin1. One or more of these values determining the format of the product (C).

The instructions on the UTXO input to the token includes verification of the or each of the inputs to the token transaction. Validation functions to inhibit the outcome being biased or fraudulently set. This can be achieved by a ‘pre-image’ of the instructions being verified e.g. using an OP_PUSH_TX, which can use messages, secured by signatured e.g. ECDSA signature messages to access and enforce the operations within the instructions. The pre-image check can force the transaction to adhere to a set of rules that limit the possible outcome of the signature process to a single value which can only be determined once the commitment transaction has been made final. This will ensure that Alice can only produce a single valid signature, and she is inhibited from being able to cycle through many signatures and/or values to generate a favourable outcome. The validation can be described as an automated validation that the instructions executed to unmask the format of the product are a valid representation of the instructions at the time the product was minted.

FIG. 3b illustrates that a commitment 300 e.g. seed values, which can optionally be provided in a template 302, is used to generate a token 304. The token can be a blockchain token generated as an output from a blockchain transaction (MTx) from which the token is minted. The token can be subsequently transferred. The token 304 includes an outcome 306, which can be a digital product 306. When minted, the outcome is masked or otherwise obscured, as indicated by the overlying pattern e.g. the seed values. The outcome e.g. one of a plurality of formats of the outcome or product is determined from the commitment, and the token script is configured to reveal or unmask the outcome when processed using a proof 308 of the commitment i.e. knowledge of the commitment is used in a transaction including the token 304 to unmask the outcome, as illustrated by the removals of the overlying pattern on the outcome 306. In one example, the commitment can be a hash of a seed value H(s) and proof of the knowledge of the seed value ‘s’ can be used to unmask the outcome. In another example, the commitment is a public key P and a value R, and the script requires knowledge of the private key ‘S’ and ‘r’ to determine the format e.g. s=k⁻¹(H(m)+S_{A}*r) mod Q.

### Trading Card Example

The method described above and claimed herein can be applied to deterministically defining a property e.g. format of a digital object, which in the present example is a trading card, typically purchased and traded to build a collection of such cards. The techniques determine a random outcome of the format through the requester (Alice) and provider (Bob) using cryptocurrency transaction protocols. In particular, the techniques can use Bitcoin (RTM) and the associated Elliptic Curve Digital Signature Algorithm (ECDSA), however any digital signature algorithm can be applied.

The methods herein are analogous to real-world events in which collector's cards are purchased to trade. Further below, the deterministic creation of masked trading cards, effectively sealed, is comparably applicable to requesting an outcome in a game of chance e.g., the roll of a dice, as described further below. It is to be noted that the solution herein provides an improved secure and deterministic method of generating outcomes to inhibit dishonest practices of forcing or revealing a result ahead of a purchase or application.

In this trading card example, a digital equivalent to a physical packet of trading cards is purchased, which a user would typically experience in a high-street shop. Rather than a pack containing 10 cards, which are randomly added to the pack at the factory where they are manufactured, a minting transaction generates a token comprising 10 cards, or 10 tokens each having a card, wherein the cards are digital objects and their format is masked. In the physical world, it is assumed that the purchaser cannot have knowledge of the cards in the pack except to know that all cards will be randomly selected from a known set. Cards are random and can be from a small or large set, or have different properties such as rarity, or properties useful in a game e.g. Pokemon®, Magic—the Gathering®. Once a user has taken possession of a physical pack, the outcome of their purchase is determined by events that took place in the factory where the pack was manufactured, however the user cannot determine the outcome without destroying the integrity of the packaging containing the cards. Similarly, the minted tokens and masked cards can only be revealed by a purposeful and irreversible action on the part to the requester than has purchased the cards, or the digital objects representing the cards.

In the examples herein, the requester i.e. the end user acquiring a card, whether physical or digital, has a comparable experience of having an uncertain outcome, while knowing that the outcome is fixed by a deterministic action. The deterministic action in the physical world is performed in the factory where cards are sealed in packs by the provider, while the format of the digital equivalent is based upon a commitment made by the requester. Unmasking the format or outcome of a digital object is analogous to a user tearing open the pack of cards, throwing a dice, a croupier throwing a roulette ball or a bingo-call.

Trading card issuance via a token is performed by an or their agent via a mint transaction, which has the authority to issue tokens either one at a time or as a set. Tokens can be issued in a format, and have traceability, with mint data identifying the issuer as the first output of the transaction, and tokens occupying subsequent outputs of the transaction, as disclosed in WO2021/250037.

The digital objects, e.g. trading cards, are issued into a token script such that upon the subsequent spend, the properties are revealed through the creation of an Elliptic Curve Signature (ECS), and said signature must be subsequently validated to unmask the format of the trading card. The requester, who will subsequently validate the signature, can generate an unlimited number of signatures that correspond to masked trading cards.

The requester provides a public key, or an address to which the minted token is to be spent, together with a temporary key. A temporary key is preferably provided for each masked digital object e.g. trading card. The address and/or key provided are checked and locked into script and require a generated signature to be created to deterministically reveal the trading card. The deterministic outcome cannot be known by either the provider of the card or the requester who receives the token until the signature is generated. This can be achieved using a predicate written in Bitcoin (RTM) script that extracts elements of the commitment e.g. the value R, from the signature and checks it against a known value and also check the public key e.g. PA against a known value. An example of this script is:
OP_3 OP_SPLIT OP_NIP OP_1 OP_SPLIT OP_SWAP OP_SPLIT OP_DROP<R value>
OP_EQUALVERIFY OP_DUP<public key>OP_EQUALVERIFY

The above script is a simplified form which checks the R value and public key against exact values stored in the predicate. Additional security can be added by checking these values against pre-generated hashes provided by a token controller during the script definition process. An example of this script is:
OP_3 OP_SPLIT OP_NIP OP_1 OP_SPLIT OP_SWAP OP_SPLIT OP_DROP OP_HASH160
<R_hash>OP_EQUALVERIFY OP_DUP OP_HASH160<public key>OP_EQUALVERIFY

Both values can be concatenated into a single hash, and an example of this script is:
OP_3 OP_SPLIT OP_NIP OP_1 OP_SPLIT OP_SWAP OP_SPLIT OP_DROP OP_OVER OP_CAT
OP_HASH160<combined_hash>OP_EQUALVERIFY

To further ensure that the signature is locked, additional properties can be enforced such as checking the SIGHASH flags (Bitcoin (RTM) specific). An example of this script is:
OP_LENGTH OP_1SUB OP_SPLIT OP_NIP<sighash>OP_EQUALVERIFY

Once the signature has been checked to ensure its deterministic nature, the properties it imbues to the token can be extracted. Various implementations can be created which allow the deterministic properties to be applied in different ways.

### Bingo—Chain of Events

In an alternative example, the method can include taking the first signature and/or public key combination off the stack and performing a deterministic check. A second part of the script can evaluate the signature for a set of random properties e.g. 1, 2, 3 or 4 and can let different parties redeem the token depending on the outcome.

An example of this script is:

```
OP_OVER OP_3 OP_SPLIT OP_NIP OP_1 OP_SPLIT OP_SWAP OP_SPLIT OP_LENGTH
OP_1SUB OP_SPLIT OP_NIP <sighash> OP_EQUALVERIFY OP_OVER OP_CAT OP_HASH160
<combined_hash> OP_EQUALVERIFY OP_2DUP OP_CHECKSIGVERIFY OP_DROP OP_4
OP_MOD
OP_DUP OP_0 OP_EQUAL OP_IF
  OP_DROP <pubkey1> OP_CHECKSIG_OP_RETURN
OP_ENDIF
OP_DUP OP_1 OP_EQUAL OP_IF
  OP_DROP <pubkey2> OP_CHECKSIG OP_RETURN
OP_ENDIF
OP_DUP OP_2 OP_EQUAL OP_IF
  OP_DROP <pubkey3> OP_CHECKSIG OP_RETURN
OP_ENDIF
OP_DUP OP_3 OP_EQUAL OP_IF
  OP_DROP <pubkey4> OP_CHECKSIG
OP_ENDIF
```

Script can be used to create a Bingo style chain of events where ‘numbers’ are generated at random. To achieve this, the above script can be used within an OP_PUSH_TX loop to determine a series of random outcomes. By way of example, in the initial minting script there are 40 IF loops, for any of 40 outcomes. The successful IF loop can be configured to ensure that the subsequent transaction in the set has an output with a script that removes that option from the next cycle. This can be achieved by making a set such that each option is indexed by the entry point of the IF loop.

In script sequence below, a first script contains an output loop with 9 options i.e. 1, 2, 3, 4, 5, 6, 7, 8, 9. Depending on the outcome of the signature check, one of the options is determined. This allows the agent running the game to create the options for the next cycle of the game on-demand. Each output hash is a “transaction prehash message” because the agent directly controls the game, the pre-hash check can be limited to only a signature check.

An example of this script is:

OP_OVER OP_3 OP_SPLIT OP_NIP OP_1 OP_SPLIT OP_SWAP OP_SPLIT OP_LENGTH
OP_1SUB OP_SPLIT OP_NIP <sighash> OP_EQUALVERIFY OP_OVER OP_CAT OP_HASH160
<combined_hash> OP_EQUALVERIFY OP_2DUP OP_CHECKSIGVERIFY OP_DROP OP_9
OP_MOD
<[1,2,3,4,5,6,7,8,9]> OP_DROP
OP_DUP OP_0 OP_EQUAL OP_IF
<option_2,3,4,5,6,7,8,9_output_hash>
OP_ENDIF
OP_DUP OP_1 OP_EQUAL OP_IF
<option_1,3,4,5,6,7,8,9_output_hash>
OP_ENDIF
OP_DUP OP_2 OP_EQUAL OP_IF
<option_1,2,4,5,6,7,8,9_output_hash>
OP_ENDIF
OP_DUP OP_3 OP_EQUAL OP_IF
<option_1,2,3,5,6,7,8,9_output_hash>
OP_ENDIF
OP_DUP OP_4 OP_EQUAL OP_IF
<option_1,2,3,4,6,7,8,9_output_hash>
OP_ENDIF
OP_DUP OP_5 OP_EQUAL OP_IF
<option_1,2,3,4,5,7,8,9_output_hash>
OP_ENDIF
OP_DUP OP_6 OP_EQUAL OP_IF
<option_1,2,3,4,5,6,8,9_output_hash>
OP_ENDIF
OP_DUP OP_7 OP_EQUAL OP_IF
<option_1,2,3,4,5,6,7,9_output_hash>
OP_ENDIF
OP_DUP OP_8 OP_EQUAL OP_IF
<option_1,2,3,4,5,6,7,8_output_hash>
OP_ENDIF

This sequence completes with an output hash that has all but the removed option.

Consider that this loop results in option 3 being chosen, an example of this script is:

```
OP_OVER OP_3 OP_SPLIT OP_NIP OP_1 OP_SPLIT OP_SWAP OP_SPLIT OP_LENGTH
OP_1SUB OP_SPLIT OP_NIP <sighash> OP_EQUALVERIFY OP_OVER OP_CAT OP_HASH160
<combined_hash> OP_EQUALVERIFY OP_2DUP OP_CHECKSIGVERIFY OP_DROP OP_8
OP_MOD
<[1,2,4,5,6,7,8,9_]> OP_DROP
OP_DUP OP_0 OP_EQUAL OP_IF
  OP_DROP <pubkey1> OP_CHECKSIG
<option_2,4,5,6,7,8,9_output_hash>
OP_ENDIF
OP_DUP OP_1 OP_EQUAL OP_IF
  OP_DROP <pubkey2> OP_CHECKSIG OP_RETURN
<option_1,4,5,6,7,8,9_output_hash>
OP_ENDIF
OP_DUP OP_2 OP_EQUAL OP_IF
  OP_DROP <pubkey3> OP_CHECKSIG OP_RETURN
<option_1,2,5,6,7,8,9_output_hash>
OP_ENDIF
OP_DUP OP_3 OP_EQUAL OP_IF
  OP_DROP <pubkey4> OP_CHECKSIG
<option_1,2,4,6,7,8,9_output_hash>
OP_ENDIF
OP_DUP OP_4 OP_EQUAL OP_IF
<option_1,2,4,5,6,7,8,9_output_hash>
OP_ENDIF
OP_DUP OP_5 OP_EQUAL OP_IF
<option_1,2,3,4,6,7,8,9_output_hash>
OP_ENDIF
OP_DUP OP_6 OP_EQUAL OP_IF
<option_1,2,3,4,5,7,8,9_output_hash>
OP_ENDIF
OP_DUP OP_7 OP_EQUAL OP_IF
<option_1,2,3,4,5,6,8,9_output_hash>
OP_ENDIF
OP_DUP OP_8 OP_EQUAL OP_IF
<option_1,2,3,4,5,6,7,9_output_hash>
OP_ENDIF
```

This approach can be scaled to hundreds or thousands of options by adding IF loops. The complexity is limited to calculating N−1 transaction pre-images where N is the number of options in the current round. Implementation can be achieved with a low grade microcontroller. By way of example, an app can be embedded into a mobile ‘bingo wheel’ which is linked to a printing apparatus that could print out ‘bingo charts’ that have lists of outcomes in a particular order.

### Bingo—Tokens

In an extension of the ‘bingo’ example, ‘player tokens’ can be issued to each player in the form of an array. By way of a non-limiting example, a 3×3 grid is filled with the 9 numbers, listed randomly. To obtain a card, a requester can make a commitment and sign with a corresponding signature to unlock the format. The product or outcome can be displayed on a device screen or printed to paper for manual use. A QR code with the token output and a private key can be used to readily identify the token corresponding to the sheet. In this example, a deterministic state is generated by processing the signature message 8 times, to determine which digit is next in the series. A key distinction of this process is that the player's device must first generate the signature, and only then can it fill out the rest of the transaction output. An example of this script is:

OP_OVER OP_3 OP_SPLIT OP_NIP OP_1 OP_SPLIT OP_SWAP OP_SPLIT OP_LENGTH
OP_1SUB OP_SPLIT OP_NIP <sighash> OP_EQUALVERIFY OP_OVER OP_CAT OP_HASH160
<combined_hash> OP_EQUALVERIFY OP_2DUP OP_CHECKSIGVERIFY OP_DROP
<0x010203040506070809> // Each iteration of the array goes here
OP_OVER OP_9 OP_MOD OP_SPLIT OP_1 OP_SPLIT OP_SWAP OP_CAT OP_CAT
OP_OVER OP_8 OP_MOD OP_SPLIT OP_1 OP_SPLIT OP_SWAP OP_CAT OP_CAT
OP_OVER OP_7 OP_MOD OP_SPLIT OP_1 OP_SPLIT OP_SWAP OP_CAT OP_CAT
OP_OVER OP_6 OP_MOD OP_SPLIT OP_1 OP_SPLIT OP_SWAP OP_CAT OP_CAT
OP_OVER OP_5 OP_MOD OP_SPLIT OP_1 OP_SPLIT OP_SWAP OP_CAT OP_CAT
OP_OVER OP_4 OP_MOD OP_SPLIT OP_1 OP_SPLIT OP_SWAP OP_CAT OP_CAT
OP_OVER OP_3 OP_MOD OP_SPLIT OP_1 OP_SPLIT OP_SWAP OP_CAT OP_CAT
OP_OVER OP_2 OP_MOD OP_SPLIT OP_1 OP_SPLIT OP_SWAP OP_CAT OP_CAT
<020407030109060805> \\ This data item is generated after the signature is determined.
OP_DUP OP_0 OP_EQUAL OP_IF
<option_2,3,4,5,6,7,8,9_output_hash>
OP_ENDIF
OP_DUP OP_1 OP_EQUAL OP_IF
<option_1,3,4,5,6,7,8,9_output_hash>
OP_ENDIF
OP_DUP OP_2 OP_EQUAL OP_IF
<option_1,2,4,5,6,7,8,9_output_hash>
OP_ENDIF
OP_DUP OP_3 OP_EQUAL OP_IF
<option_1,2,3,5,6,7,8,9_output_hash>
OP_ENDIF
OP_DUP OP_4 OP_EQUAL OP_IF
<option_1,2,3,4,6,7,8,9_output_hash>
OP_ENDIF
OP_DUP OP_5 OP_EQUAL OP_IF
<option_1,2,3,4,5,7,8,9_output_hash>
OP_ENDIF
OP_DUP OP_6 OP_EQUAL OP_IF
<option_1,2,3,4,5,6,8,9_output_hash>
OP_ENDIF
OP_DUP OP_7 OP_EQUAL OP_IF
<option_1,2,3,4,5,6,7,9_output_hash>
OP_ENDIF
OP_DUP OP_8 OP_EQUAL OP_IF
<option_1,2,3,4,5,6,7,8_output_hash>
OP_ENDIF

### Dice-Roll Example

In another example, Bob's casino uses the methods herein to create a weighted dice game. Alice visits Bob's casino website and connects using her Bitcoin (RTM) paymail account using Zero Auth, which is a well-known technique for establishing Bitcoin (RTM) payments.

Once Alice has connected to the website she identifies the game she wants to play, selects the ‘dice’ game and reviews the odds. Bob's dice game presents Alice with the following odds based on modulo 21:

$$Dice roll = 1 : 1 / 21 ( MODULO 21 = 0 ) i . e . , Dice roll = 1 , if mod 21 = 0$$

$$Dice roll = 2 : 2 / 21 ( MODULO 21 >= 1 AND MODULO 21 <= 2 )$$

$$Dice roll = 3 : 3 / 21 ( MODULO 21 >= 3 AND MODULO 21 <= 5 )$$

$$Dice roll = 4 : 4 / 21 ( MODULO 21 >= 6 AND MODULO 21 <= 9 )$$

$$Dice roll = 5 : 5 / 21 ( MODULO 21 >= 10 AND MODULO 21 <= 14 )$$

$$Dice roll = 6 : 6 / 21 ( MODULO 21 >= 15 AND MODULO 21 <= 20 )$$

In this example, a dice roll of ‘1’ occurs when the result of X mod 21=0, which has approximately a 4.8% chance.

Alice gambles of rolling the dice to produce a “4” as her number, which occurs if the outcome of the modulo 21 operation is 6, 7 or 8, having a 4.8% chance. Upon choosing “4”, Bob's paymail host requests from Alice (i) a public key that she will sign with, said public key created as part of a key-pair and having a corresponding private key, and (ii) a value for R derived from a key e.g. an ephemeral private key. The public key and the value of R can be independent i.e. unrelated. The public key and/or the value of R function as a commitment.

After receiving the public key and the value of R, Bob's paymail host generates a script that performs the functions: checks that the public key submitted is Alice's public key; checks the R-value in her signature to make sure it is Alice's R value; and checks a transaction pre-image using the OP_PUSH_TX technique to validate the transaction Alice is signing meets certain requirements.

OP_PUSH_TX is a technique where a ‘transaction pre-image’ message is pushed into the transaction in the scriptSig. The pre-image can be parsed into the following items:
1. <transaction version> (4 bytes)
2. Hash of Prevouts (concatenation of input source/sources) (defined by SIGHASH) (32 bytes)
3. Hash of Sequence (concatenation of input nSequence value/values) (defined by SIGHASH) (32 bytes)
4. Outpoint for input being spent (TXID/Vout) (32 bytes+4 bytes)
5. Locking script for input being spent (Transaction dependent, defined by OP_CODESEPARATOR)
6. Value of input being spent (in satoshis) (8 bytes)
7. nSequence value for input being spent (4 bytes)
8. Hash of output/outputs being signed (defined by SIGHASH) (32 bytes)
9. Transaction nLocktime (4 bytes)
10. Sighash flag (4 bytes, XX000000 where XX is Sighash Flag)

Once the validation of parameters has been performed in script the pre-image is put through a hash function and the hash signed using the private key ‘1’. Because of the mathematics used in ECDSA, the outcome of signing with public key 1 is the unmodified hash, so we can generate a valid signature and present the public key that corresponds to the private key ‘1’ and show through a consensus checked evaluation that the transaction pre-image that is submitted is valid. Bob's script checks the following elements of the pre-image:
1. That the transaction version is 0x01
2. nSequence value for input being spent is 0xFFFFFFFF (nSequence is final)
3. Transaction nLocktime (4 bytes) is 0x00000000 (mine anytime)
4. Sighash flag is SIGHASH_NONE|SIGHASH_ANYONECANPAY|SIGHASH_FORKID

The version is checked as it can be modified to different values to change pre-image values to generate multiple signatures offline. Checking is performed because the nSequence value can be cycled through over 4 billion values allowing Alice to determine or influence the dice throw. Further, the nLocktime can be changed allowing different pre-images to be used so we check that it is fixed. The SIGHASH flag SIGHASH_NONE instructs the evaluator that the sighash message does not include any outputs in the signature. The SIGHASH flag SIGHASH_ANYONECANPAY instructs the evaluator that only this input is signed with the signature, which forces item 8, in the pre-image list of items below, to be a 32 byte string of zeroes and excludes sequence values for any other inputs from item 3 in the list. By way of example, forcing the values listed below can limit the pre-image to the following:
1. Fixed version
2. String of 32 0's (SIGHASH_ANYONECANPAY)
3. Hash of nSequence of 0xFFFFFFFF for this input only (due to SIGHASH)
4. The fixed outpoint where this script is held (can't be changed)
5. The locking script for this outpoint (can't be changed)
6. The value of this outpoint in satoshis (can't be changed)
7. A fixed nSequence value of 0xFFFFFFFF
8. A string of 32 0's (no outputs in pre-image)
9. A fixed nLocktime of 0x00000000
10. SIGHASH_NONE|SIGHASH_ANYONECANPAY|SIGHASH_FORKID

Once the script hash checked that the transaction properties and/or signature meet all of these requirements, the script can continue processing Alice's game. Next, a check is performed to ensure that Alice's signature carries the identical SIGHASH flag to that of the pre-image, that her public key is the one she submitted and that R is the R value she submitted. By performing these checks, Alice's signature can be validated to ensure that it was the only possible valid signature for this particular output.

Once created, Alice's signature is passed through a MODULO 21 function where the outcome is used to assign her winnings. In this case, if the output is between 6 and 9 (e.g. 6,7, 8 or 9) then Alice wins.

If Alice wins, a second pre-image check can be performed by signing using SIGHASH_SINGLE and we check that item 8 in the pre-Image matches the hash of an output that pays the correct amount to a script Alice controls. Otherwise, Bob awards the stake to himself. Bob, or an operator representing Bob, is the controller of the game so in this instance he can make the payment without doing the corresponding output check in script.

### Device/System

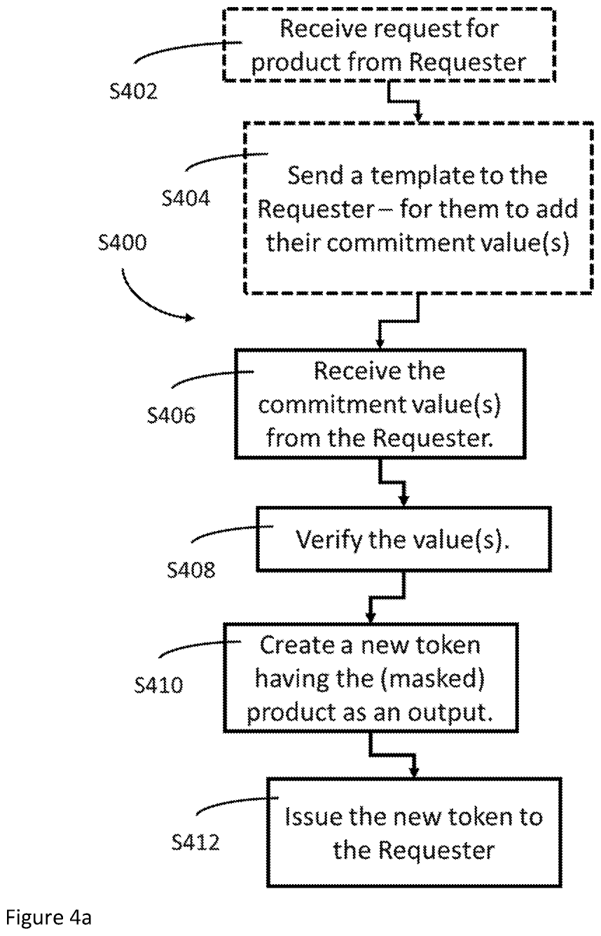

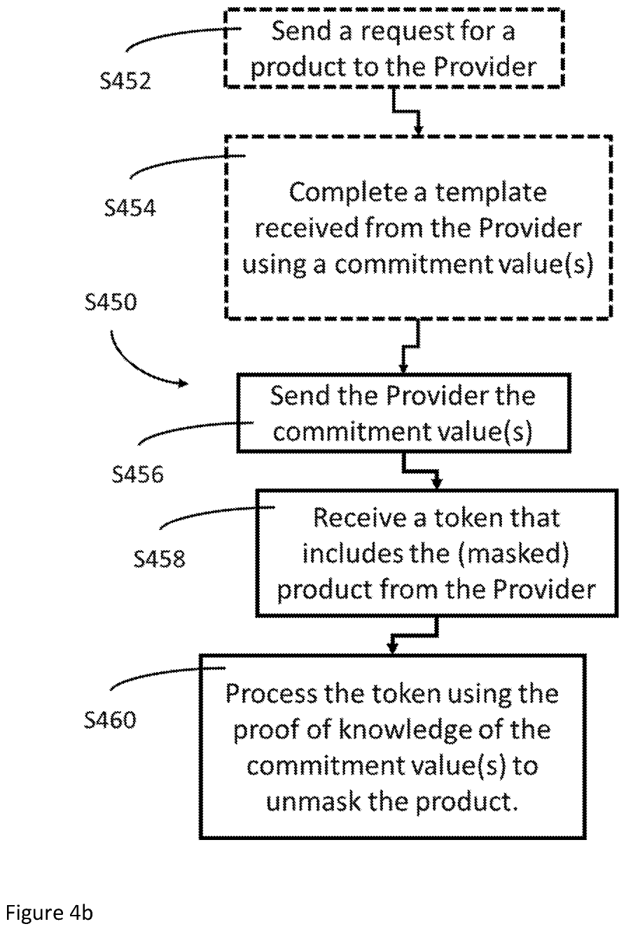

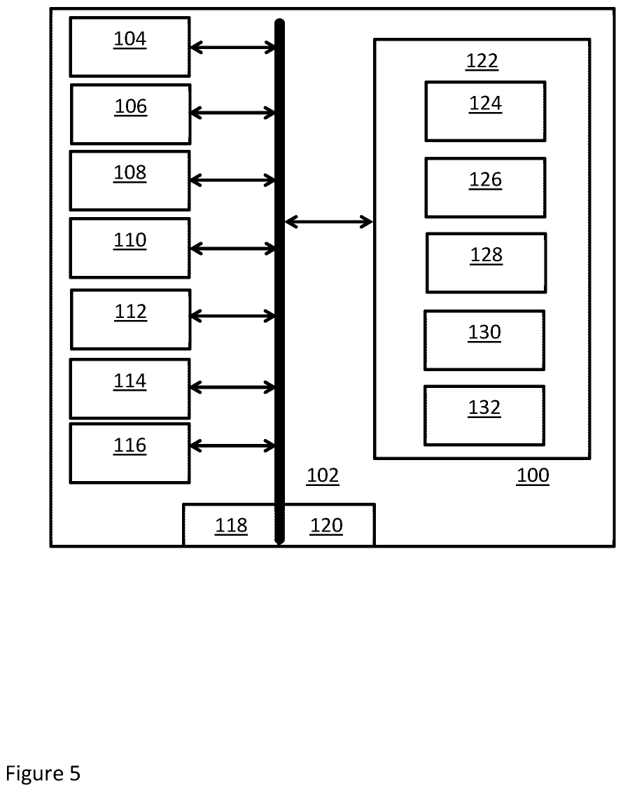

Examples of the actions S400, S450 of the provider and the requester are illustrated in FIGS. 4a and 4b respectively. In FIG. 4a, the provider can receive S406 a request for an outcome having a given format and a commitment value or values that determines the outcome e.g. format of the product. Optionally, the provider can receive a request S402, and send S404 a template for the requester to complete using their commitment. The provider can verify S408 the values provided by the requester. Using the commitment values, the provider can generate S410 a token, which can be a new token, having a masked output that provides an outcome or product requested by the requester. The token is then issued S412 to the requester from the provider. As described herein, the output from the token i.e. the outcome or product is masked, wherein said mask is secured using the commitment value or values. The outcome or product can be unmasked using a proof i.e. proof of knowledge of the commitment value or values. When the token is processed using the proof the outcome or product is unmasked and its format is revealed.

FIG. 4b outlines the corresponding actions S450 of the requester, in which the requester sends a request S456 for an outcome having a given format and a commitment value or values that determines the outcome e.g. format of the product. Optionally, the requester can send a request S452, receive a template to which they can add their commitment value or values S454, and send said completed template to the provider. The provider creates a token that is sent to the requester, and the requester receives S458 a token having a masked output that provides the outcome or product requested. The token is then processed S460 using the proof of the commitment value or values i.e. proof of knowledge of the commitment value or values. When the token is processed using the proof the outcome or product is unmasked and its format is revealed. The requester, therefore, has control of a token having a given output of product having a format determined from the commitment value or values.

### Device/System

The invention can be implemented on a device. An example of a device having a controller and a control system is illustrated in FIG. 4. A device 100 can be scalable in size and across different locations to implement an aspect or method of the invention described herein. The device can also be representative of an input device such as a sensor or an output device such as an actuator. The device 100 includes a bus 102, at least one processor 104, at least one communication port 106, a main memory 108 and/or a removable storage media 110, a read only memory 112 and a random access memory 114. The components of device 100 can be configured across two (2) or more devices, or the components can reside in a single device 10. The device can also include a battery 116. The port 106 can be complimented by input means 118 and output connection 120. The processor 104 can be any such device such as (but not limited to) an Intel (RTM), AMD (RTM) or ARM (RTM) processor. The processor may be specifically dedicated to the device. The port 106 can be a wired connection, such as an RS-232 connection, or a Bluetooth (RTM) connection or any such wireless connection. The port can be configured to communicate on a network such a Local Area Network (LAN), Wide Area Network (WAN), or any network to which the device 100 connects. The read only memory 112 can store instructions for the processor 104.

The bus 102 communicably couples the processor 104 with the other memory 110, 112, 114, 108 and port 106, as well as the input and output connections 118, 120. The bus can be a PCI/PCI-X or SCSI based system bus depending on the storage devices used, for example. Removable memory 110 can be any kind of external hard-drives, floppy drives, flash drives, for example. The device and components therein are provided by way of example and does not limit the scope of the invention. The processor 104 can implement the methods described herein. The processor 104 can be configured to retrieve and/or receive information from a remote server or other device.

The device 100 can also include an embedded system 122 and contain a secure module 124 having an associated private key. A key store 126 can hold the key-pairs assigned to the control signals of the system. A device can include a secure mechanism 128 for generating key-pairs for use in signing the UTXO of a token, and the secure mechanism can include a physical unclonable function (PUF). The operational history of the device can be held in a back-up store 128. A local copy 130 of the token transactions associated with the device ledger can be stored on the device. A separate data store 132 can hold at least one of the device identity, authority information, finite-state machine configurations and keypairs of the input devices.

### General Overview

Bob is a provider of an asset, which can be represented digitally using a digital token, such as a blockchain token. Such a token, or derivative thereof e.g. sub-token, can be minted and represent the asset. The initial token minted can be configured with a hidden or concealed output e.g. format, which is unknown until unlocked. In the examples above a sealed card is described e.g. a trading card, which is revealed upon processing the token. The security provided by the teaching herein enables greater, or at least analogous, levels of security to a sealed trading card, in which the outcome is fixed and unknown prior to the seal being broken. Alice is a requester who wants to obtain the asset. The interactions between Alice and Bob taught herein ensure fair-play and inhibit manipulation of the outcome.

To inhibit manipulation, Alice can provide at least one value to Bob, said value functioning as a commit in a commitment scheme. Alternatively, Bob can provide Alice with a means e.g. set of instructions in which to include her value and return to Bob upon completion. In many examples herein, Alice's value is unique to her. Additionally or alternatively, Alice can agree to a future value, which is yet unknown, that functions as a commitment i.e. an established agreement to determine the outcome based on this future value and determines the outcome of the asset. An example of a future unknown value can be a hash of the 100^{th} block header from now.

After Bob has received Alice's values, or commitment to a value, it can be used to determine the outcome e.g. format of the asset that Bob provides to Alice. Alice can receive the asset in masked form i.e. she is provided with an asset that must be processed to reveal the outcome, said processing requiring knowledge of the value she initially provided to Bob. Alice's value is used to determine the outcome. The outcome is deterministically based upon her value. Neither Alice nor Bob, therefore, can manipulate the outcome.

In one example, to inhibit the deterministic outcome from being manipulated, Bob as the provider asks Alice for a public key P_{A} from a key-pair that she will sign with, and a value for R for her signature, to check it is her R value. Bob checks the public key P_{A} belongs to Alice, and checks the R value in Alice's signature matches the R value provided. This can be achieved using a script, with which Alice can interact. The script can check a transaction pre-image using the OP_PUSH_TX technique to validate the transaction Alice is signing meets certain requirements. When Alice's information has been verified, Bob can issue the asset, which is masked i.e. the format is hidden or blinded e.g. a sealed trading card. The asset can be issued in the form of a blockchain token e.g. a token UTXO. The asset can be assigned to Alice using her public key P_{A}. The format of the asset can only be revealed using Alice's corresponding private key S_{A}. Revealing the format can be implemented by processing instructions e.g. script included in the blockchain token. Processing an unlocking script determines the outcome e.g. format of the asset e.g. trading card.

The outcome can be determined, in one example, using a multiplier of Alice's private key, S_{A}, and an operand e.g. mod X. For example, format=S_{A} mod X, where X is the number of different formats of the asset. In another example, the format=(SHA256 (issuanceTXID, index))*MODULO 100, wherein each combination of TXID/Index will produce a pseudorandom hash value between 0 and 99, which enables the issuer to define 100 different trading cards which each correspond to one output of the hash function. The outcome can be weighted through sub-division of the operand e.g. the modulo. Alice reveals the outcome or format of the asset by processing the instructions using the value she committed to, which can be a private key or the future value she agreed to use.

It should be noted that the above-mentioned examples illustrate rather than limit the disclosure, and that those skilled in the art will be capable of designing many alternative examples without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. Throughout this specification the word “comprise”, or variations such as “includes”, “comprises” or “comprising”, will be understood to imply the inclusion of a stated element, integer or step, or group of elements, integers or steps, but not the exclusion of any other element, integer or step, or group of elements, integers or steps. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

In this document we use the term ‘blockchain’ to include all forms of electronic, computer-based, distributed ledgers. These include consensus-based blockchain and transaction-chain technologies, permissioned and un-permissioned ledgers, shared ledgers, public and private blockchains, and variations thereof. As the Bitcoin (RTM) ledger is the most widely known application of blockchain technology it will be used herein for ease of reference, although it should be noted that the term “Bitcoin (RTM)” is intended herein to refer to any version or variation that derives from, or is based on, the Bitcoin (RTM) protocol. Moreover, other non-Bitcoin (RTM) blockchain implementations have been proposed and developed and alternative blockchain implementations and protocols fall within the scope of the present disclosure.

The term “user” may refer herein to a human or a processor-based resource.

The skilled person will readily understand that in the art it is usual to refer to spending of cryptocurrency in terms of sending coins from one address/owner to another. However, in reality, no actual “coins” are transferred. Instead, control of ownership is transferred from one script to another. As used herein, phrases “quantity/amount/portion of cryptocurrency”, “non-negative quantity etc of cryptocurrency” and the like are intended to mean zero or more units of a cryptocurrency e.g. >=0 Satoshi in relation to Bitcoin (RTM).

1. A computer-implemented method comprising:
using, processing and/or generating a blockchain transaction (MTx) having at least one token-related output (T-UTXO) that creates and transfers a token (T) to a requester, wherein the token comprises: at least one output defining a product (C) having a format (F), wherein said format is one of a plurality of formats (F), masked, and determinable by processing a commitment; and instructions (m) configured to process the commitment to unmask and determine the format (F).

2. The method of claim 1, further comprising receiving from the requester the commitment.

3. The method of claim 1 or 2, wherein
the commitment comprises an input value, such as a digital signature, the input value is used to lock the instructions (m), and knowledge of the input value is used to determined a proof of the commitment, which is processed to unlock said instructions.

4. The method of any preceding claim, wherein the commitment includes at least one of
a public key (PA) derived from a key-pair including a private key (SA),
a component (R) derived from a key (k), and an expected value to be derived from a future unknown value.

5. The method of claim 4, wherein the public key (PA) is derived from
$${P}_{A =} {S}_{A} \cdot G$$
wherein
S_{A} is the private key, and
G is an elliptic curve generator point.
and/or the commitment (R) is derived from
$$R = k \cdot G ,$$
wherein r is the x-coordinate of R,
k is a key, and
G is an elliptic curve generator point.

6. The method of any preceding claim, wherein the format of the product (C) is determined from an operation including
(i) the proof of the commitment and/or the signature, and
(ii) an operand that produces a predetermined number n of outcomes.

7. The method of any of claims 3 to 6, wherein the format of the product (C) is determined from an operation including the signature and an operand that produces a predetermined value m from a predetermined number n of outcomes.

8. The method of claim 6 or 7, wherein the operand is modulo n, wherein n is the maximum number of the plurality of formats (F).

9. The method of any of claims 4 to 8, wherein the signature(s) is
$$s = {k}^{- 1} ( H ( m ) + {S}_{A} * r ) mod Q$$
wherein
k is the key,
H(m) is a hash of the instructions
S_{A} is the private key corresponding to the public key (P_{A}) of the key-pair
r is the x-coordinate of R, and
Q is the order of the private key space.

10. The method of any preceding claim, further comprising:
providing a template set of instructions to the requester, and
receiving the commitment embedded in the template set of instructions that determine the instructions (m).

11. The method of any preceding claim, further including at least one of verifying
that the public key (P_{A}) submitted is the requestor's public key,
the commitment (R) is that of the requestor, and
a transaction pre-image to validate the transaction the requestor is signing meets predetermined criteria.

12. The method of any preceding claim, wherein:
the token has a plurality of outputs, each output defining a product (C) having a format (F); and/or
the blockchain transaction (MTx) has a plurality of token-related output (T-UTXO), each output creating and transferring a token (T) to the requester, wherein
a commitment is provided for each product (C).

13. The method of any preceding claim, wherein the blockchain transaction (MTx) further includes at least one of:
a signature of the provider unlocking the a blockchain transaction (MTx);
an input and/or an output UTXO of a provider;
a quantity of token-related cryptocurrency (TRC);
providing the or each token output with a quantity of token-related cryptocurrency (TRC); and
providing the or each token with a quantity of token-related cryptocurrency (TRC).

14. The method of any preceding claim, wherein the instructions determine a value from
a range of n outcomes, or a sub-range of n outcomes, or a deterministically random outcome by processing the commitment with a yet unknown value, wherein said value determines the format of the product (C).

15. A computer-implemented method comprising:
requesting from a provider a blockchain transaction (MTx) having at least one token-related output (T-UTXO) that creates and provides a token (T),
wherein the token comprises at least one output defining a product (C) having a format (F), wherein said format is one of a plurality of formats (F), determinable from a commitment and masked, and
instructions (m) configured to process the commitment to unmask and determine the format (F);
(i) sending a commitment (P_{A}, R) to the provider for processing by the provider to generate a set of instructions for inclusion in the blockchain transaction, or
(ii) receiving a template set of instructions from the provider, and completing the template set of instructions that determine instructions with a commitment (P_{A}, R), and sending the completed template to the provider; and
receiving the blockchain transaction and processing the instructions (m) within the blockchain transaction using a proof of the commitment to unmask and determine the format (F).

16. A computer-implemented method comprising:
sending to a requester a blockchain transaction (MTx) having at least one token-related output (T-UTXO) that creates and provides a token (T),
wherein the token comprises
at least one output defining a product (C) having a format (F), wherein said format is one of a plurality of formats (F), determinable from a commitment and masked, and
instructions (m) configured to process the commitment to unmask and determine the format (F);
(i) receiving a commitment (P_{A}, R) from the requester for processing to generate a set of instructions for inclusion in the blockchain transaction, or
(ii) sending a template set of instructions to the requester, and receiving a completed template set of instructions that determine instructions and include a commitment (P_{A}, R); and
broadcasting the blockchain transaction for the requester to process the instructions (m) within the blockchain transaction using a proof of the commitment to unmask and determine the format (F).

17. The method of claim 15 or 16, further comprising executing instructions (m) of the token (T) using the commitment and unmasking and determining the format (F) of the product (C).

18. Computer equipment comprising memory comprising one or more memory units; and processing apparatus comprising one or more processing units, wherein the memory stores code arranged to run on the processing apparatus, the code being configured so as when on the processing apparatus to perform the method of any of claims 1 to 17.

19. A computer program embodied on computer-readable storage and configured so as, when run on one or more processors, to perform the method of any of claims 1 to 17.
